(19) United States
(12) Patent Application Publication
(10) Pub. No.: US 2014/0202270 A1
(43) Pub. Date: Jul. 24, 2014

(54) WORKTABLE SLIDING BLOCK POSITIONING MECHANISM

(71) Applicant: CARPENTER MACHINERY CO., LTD, Taichung City (TW)

(72) Inventor: Chin-Hsueh CHANG, Taichung City (TW)

(73) Assignee: CARPENTER MACHINERY CO., LTD, Taichung City (TW)

(21) Appl. No.: 13/828,172

(22) Filed: Mar. 14, 2013

(30) Foreign Application Priority Data
Jan. 18, 2013 (TW) 102201220

(51) Int. Cl. B23Q 1/44

(52) U.S. Cl. CPC B23Q 1/44
USPC 74/54

(57) ABSTRACT

A worktable sliding block positioning mechanism includes abuse member pivotally connected to a sliding block, a first clamping block affixed to the base member and defining a first clamping end that is disposed at one side relative to the worktable, a second clamping block pivotally connected to the base member and defining a second clamping end that is disposed at an opposite side relative to the worktable and opposite to the first clamping end, and a drive wheel pivotally connected to the base member and rotatable by an external force and defining a press portion that is pressed on the second clamping block to move the second clamping end toward the first clamping end of the first clamping block upon a rotary motion of the drive wheel. Thus, the worktable sliding block positioning mechanism avoids deformation or displacement of the sliding block during its positioning.

### BACKGROUND OF THE INVENTION

1. Field of the Invention

The present invention relates to positioning technology and more particularly, to a worktable sliding block positioning mechanism.

2. Description of the Related Art

A machinery equipment generally provides a worktable for holding a workpiece for processing. During processing, the worktable works as a reference surface. Further, the worktable may be equipped with a sliding block to facilitate accurate movement of the workpiece on the worktable, and a sliding block positioning mechanism for locking the sliding block to the worktable. Linking between the aforesaid sliding block and worktable is achieved by means of a sliding rail. The sliding rail is affixed to the worktable. The sliding block is movable along the sliding rail. The sliding block positioning mechanism is affixed to the sliding block and movable along the sliding rail relative to the worktable.

A sliding block positioning mechanism is known comprising a tightening-up screw mounted in a screw hole at the sliding block. The user can rotate the tightening-up screw out of the sliding block to stop against the sliding rail, locking the sliding block to the sliding rail, and therefore, the position of the sliding block relative to the worktable is locked. However, this design of sliding block positioning mechanism is still not satisfactory in function. When tightening up the tightening-up screw against the sliding rail, the sliding rail and the sliding block will receive a pressure in reversed directions, and the sliding rail and the sliding block may be deformed or biased relative to each other. Further, the sliding rail can easily be damaged by the tightening-up screw, leading to unsmooth operation between the sliding rail and the sliding block and shortening the lifespan of the sliding rail and the sliding block.

### SUMMARY OF THE INVENTION

The present invention has been accomplished under the circumstances in view. It is the main object of the present invention to provide a worktable sliding block positioning mechanism, which prevents deformation or displacement of the sliding block due to the effect of an external force during its positioning.

To achieve this and other objects of the present invention, a worktable sliding block positioning mechanism is pivotally coupled to a sliding block that is movable along a fixed sliding rail of a worktable. The worktable sliding block positioning mechanism comprises a base member pivotally connected to the sliding block, a first clamping block affixed to the base member and defining a first clamping end that is disposed at one side relative to the worktable, a second clamping block pivotally connected to the base member and defining a second clamping end that is disposed at an opposite side relative to the worktable and opposite to the first clamping end, and a drive wheel pivotally connected to the base member and rotatable by an external force. The drive wheel defines a press portion pressable on the second clamping block to move the second clamping end toward the first clamping end of the first clamping block upon a rotary motion of the drive wheel. By means of rotating the drive wheel to force the second clamping block toward the first clamping block, the first clamping block and the second clamping block are clamped on the worktable, avoiding deformation or displacement of the sliding block due to application of a force to the sliding rail and the sliding block at the same time.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a worktable sliding block positioning mechanism in accordance with a first embodiment of the present invention.

FIG. 2 is a sectional view of the worktable sliding block positioning mechanism in accordance with the first embodiment of the present invention.

FIG. 3 is an exploded view of the worktable sliding block positioning mechanism in accordance with the first embodiment of the present invention.

FIG. 4 is a schematic drawing illustrating an operating status of the worktable sliding block positioning mechanism in accordance with the first embodiment of the present invention.

FIG. 5 is an exploded view of a worktable sliding block positioning mechanism in accordance with a second embodiment of the present invention.

FIG. 6 is a sectional view of the worktable sliding block positioning mechanism in accordance with the second embodiment of the present invention.

### DETAILED DESCRIPTION OF THE INVENTION

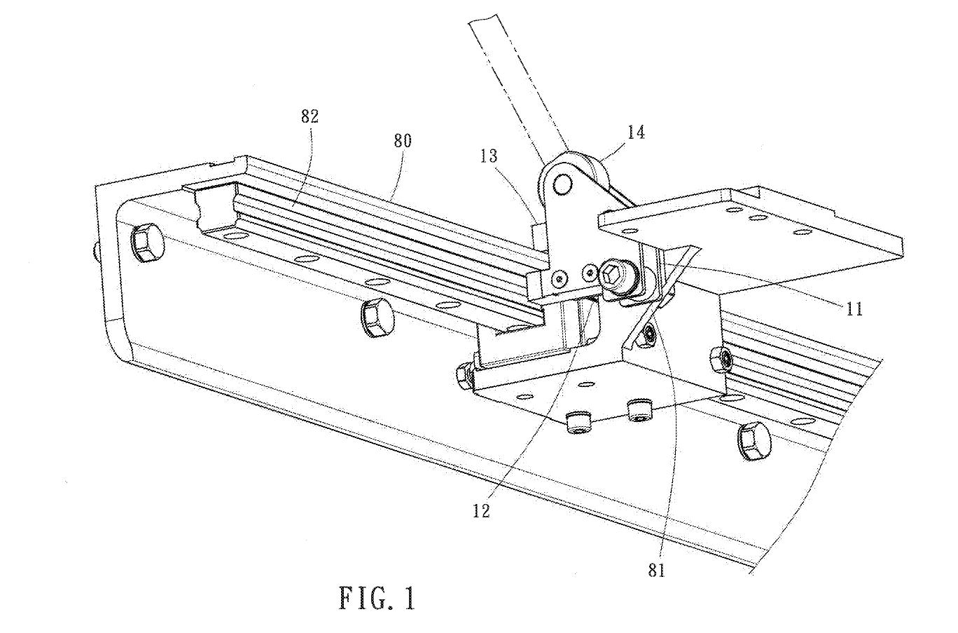

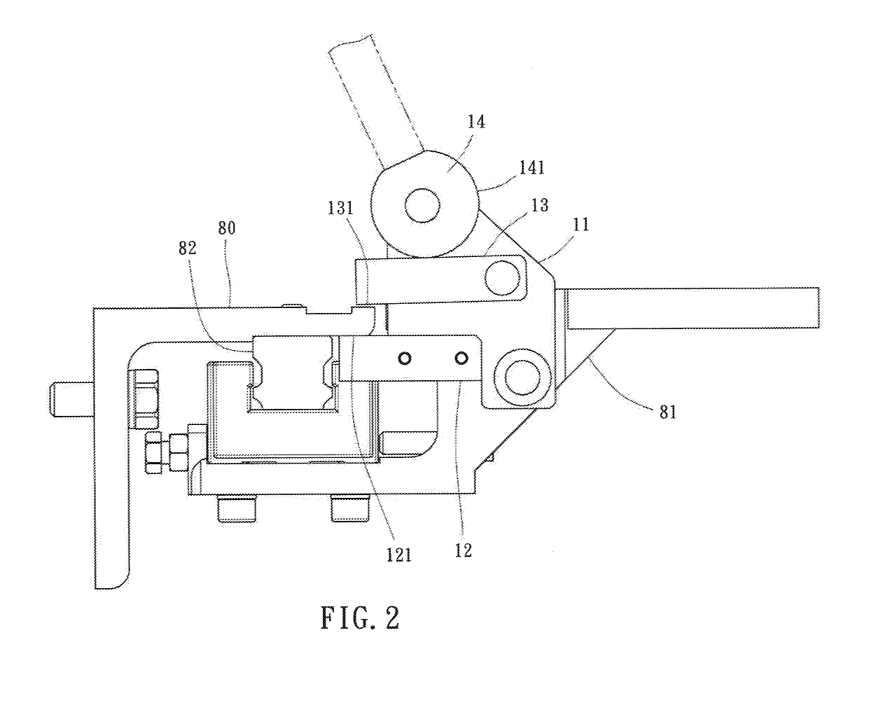

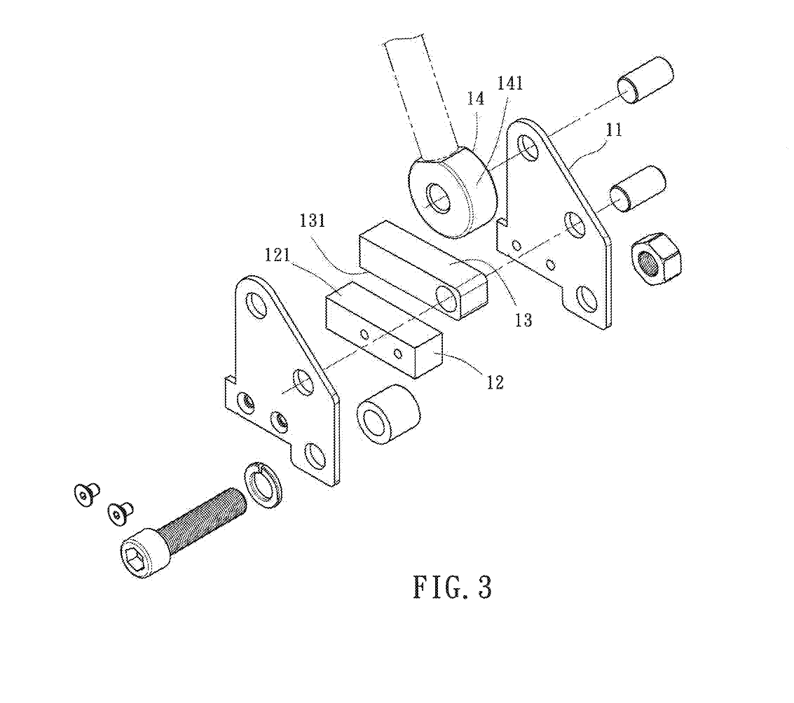

Referring to FIGS. 1-3, a worktable sliding block positioning mechanism in accordance with a first embodiment of the present invention is shown pivotally coupled to a sliding block 81 that is movable along a fixed sliding rail 82 of a worktable 80. The worktable sliding block positioning mechanism comprises a base member 11, a first clamping block 12, a second clamping block 13, and a drive wheel 14.

The base member 11 in this embodiment is a plate member pivotally coupled to the sliding block 81.

The first clamping block 12 is fixedly connected to the base member 11, defining a first clamping end 121. The first clamping end 121 is disposed at one side relative to the worktable 80. In this embodiment, the first clamping end 121 is disposed at an outer side relative to the bottom wall of the worktable 80.

The second clamping block 13 is pivotally connected to the base member 11, defining a second clamping end 131. The second clamping block 13 is disposed at one side relative to the worktable 80. In this embodiment, the second clamping end 131 is disposed at an outer side relative to the top wall of the worktable 80 opposite to the first clamping end 121 of the first clamping block 12.

The drive wheel 14 is pivotally mounted at the base member 11 and rotatable by an external force. The drive wheel 14 defines a press portion 141 that is pressed on the second clamping block 13 after having being rotated, forcing the second clamping end 131 to approach to the first clamping end 121 of the first clamping block 12 so that the first clamping end 121 and the second clamping end 131 can touch the worktable 80, enabling the first clamping block 12 and the second clamping block 13 to be clamped on the worktable 80.

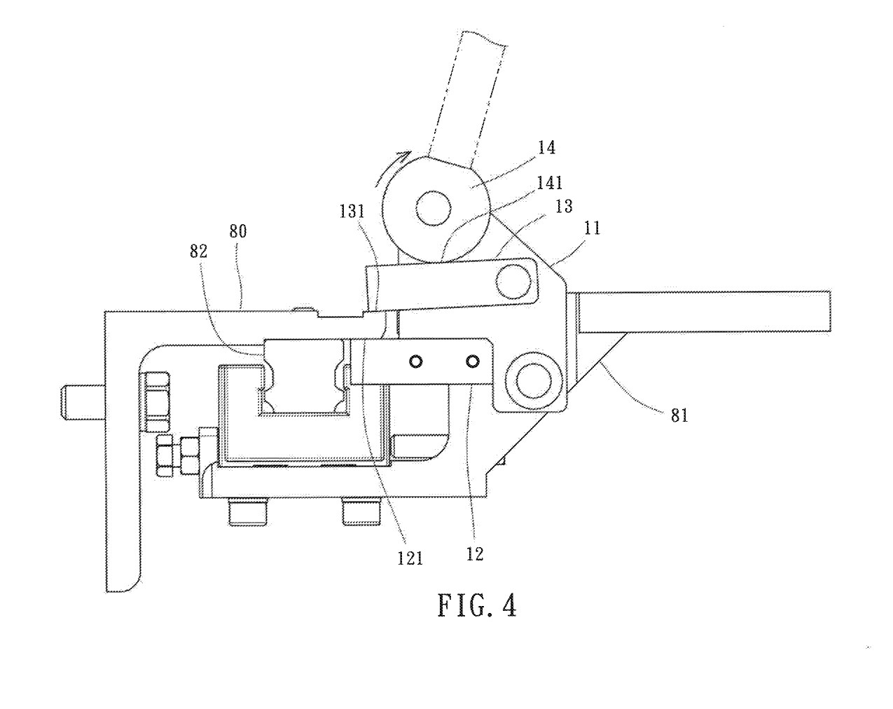

As shown in FIG. 4, by means of rotating the drive wheel 14 to press the press portion 141 on the second clamping block 13 and to further force second clamping block 13 in direction toward the first clamping block 12, the first clamping block 12 and the second clamping block 13 are clamped on the worktable 80, achieving the object of the present invention of avoiding deformation or displacement of the sliding block caused by applying a force to the sliding rail 82 and the sliding block 81 at the same time. On the other hand, it is to be noted that, subject to the arrangement that the base member 11 is pivotally connected to the sliding block 81, the base member 11 will be turned relative to the sliding block 81 when clamping the first clamping block 12 and the second clamping block 13 on the worktable 80, and therefore, the first clamping block 12 and the second clamping block 13 can be positively clamped on the worktable 80 even if there is a contained angle defined between the worktable 80 and the sliding block 81, preventing deformation or displacement between the sliding rail 82 and the sliding block 81 and enhancing the application flexibility of the worktable sliding block positioning mechanism.

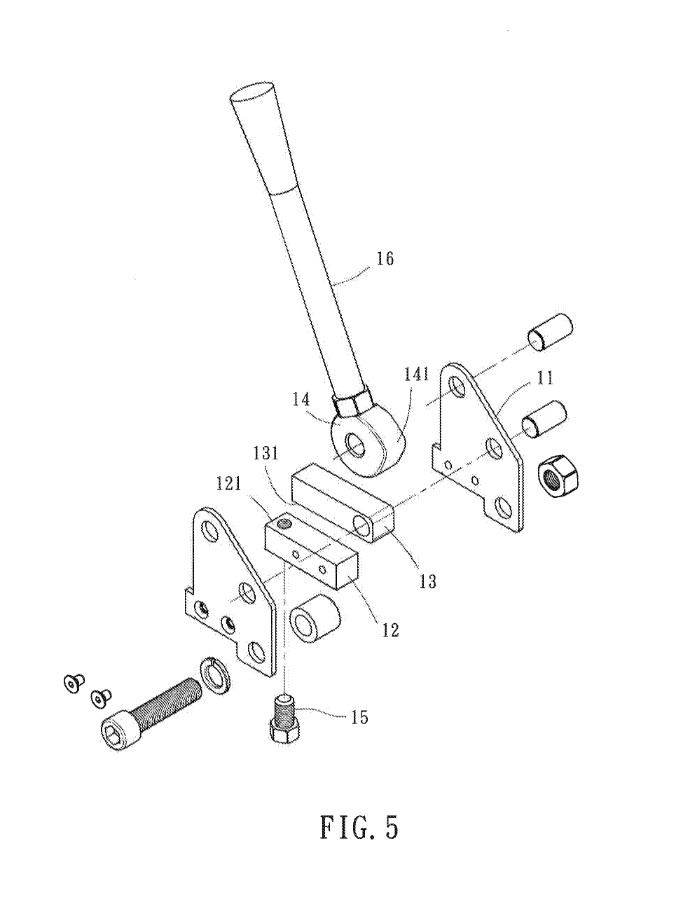

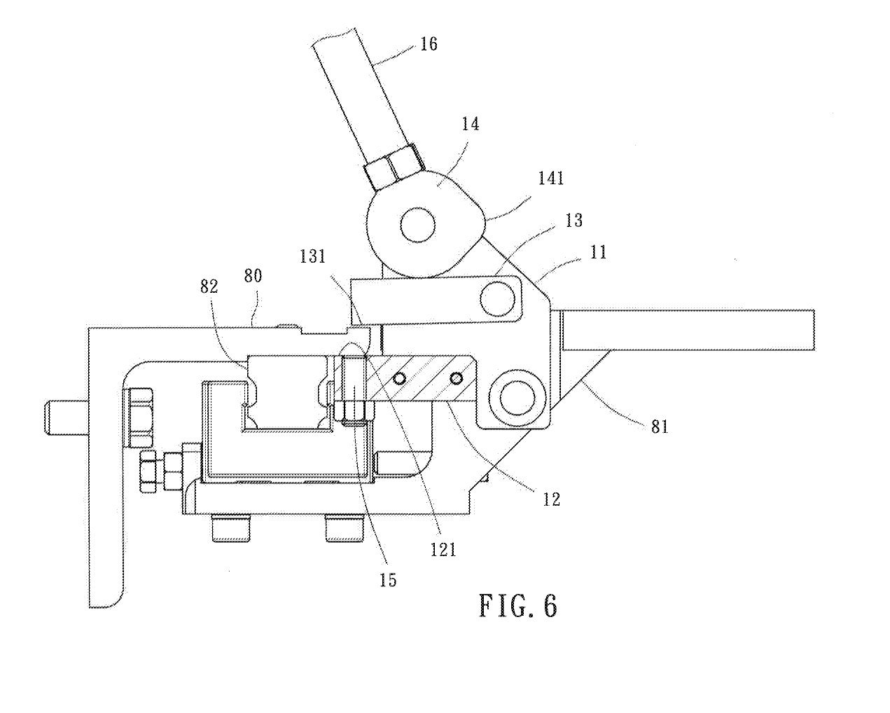

Referring to FIGS. 5 and 6, a worktable sliding block positioning mechanism in accordance with a second embodiment of the present invention is shown. This second embodiment is substantially similar to the aforesaid first embodiment with the exception that an adjustment screw 15 is inserted through the first clamping end 121 of the first clamping block 12 and protruding over one side of the first clamping block 12. After the first clamping block 12 and the second clamping block 13 are clamped on the worktable 80, the user can rotate the adjustment screw 15 to adjust the distance between the first clamping block 12 and the second clamping block 13, regulating the clamping force.

Further, it is to be noted that the drive wheel 14 used in either of the aforesaid first embodiment or second embodiment is an eccentric wheel, and the press portion 141 is the farthest point away from the center of rotation of the drive wheel. Similarly, the drive wheel 14 can be a cam that achieves the same effects. In this case, the press portion 141 is a flange formed on the periphery of the drive wheel 14.

Further, an operating rod member 16 can be provided in the aforesaid first embodiment or second embodiment and detachably connected to the drive wheel 14. The user can operate the operating rod member 16 to rotate the drive wheel 14.

Although particular embodiments of the invention have been described in detail for purposes of illustration, various modifications and enhancements may be made without departing from the spirit and scope of the invention, for example, the lengths of the bands can be made adjustable. Accordingly, the invention is not to be limited except as by the appended claims.

1. A worktable sliding block positioning mechanism pivotally coupled to a sliding block that is movable along a fixed sliding rail of a worktable, the worktable sliding block positioning mechanism comprising:
a base member pivotally connected to said sliding block;
a first clamping block affixed to said base member, said first clamping block defining a first clamping end disposed at one side relative to said worktable;
a second clamping block pivotally connected to said base member, said second clamping block defining a second clamping end disposed at an opposite side relative to said worktable and opposite to said first clamping end; and
a drive wheel pivotally connected to said base member and rotatable by an external force, said drive wheel defining a press portion pressable on said second clamping block to move said second clamping end toward said first clamping end of said first clamping block upon a rotary motion of said drive wheel.

2. The worktable sliding block positioning mechanism as claimed in claim 1, wherein said first clamping block comprises an adjustment screw inserted through said first clamping end and protruding over one side of said first clamping block.

3. The worktable sliding block positioning mechanism as claimed in claim 1, wherein said drive Wheel is an eccentric wheel., and said press portion is located at the farthest point of said drive wheel away from the center of rotation of said drive wheel.

4. The worktable sliding block positioning mechanism as claimed in claim 1, wherein said drive wheel is a cam, and said press portion is a flange formed on the periphery of said drive wheel.

5. The worktable sliding block positioning mechanism as claimed in claim 3, further comprising an operating rod member detachably connected to said drive wheel and operable by a user to rotate said drive wheel.

6. The worktable sliding block positioning mechanism as claimed in claim 4, further comprising an operating rod member detachably connected to said drive wheel and operable by a user to rotate said drive wheel.
